(19) United States
(12) Patent Application Publication
(10) Pub. No.: US 2026/0122196 A1
(43) Pub. Date: Apr. 30, 2026

(54) IMAGE FORMING APPARATUS AND SYSTEM

(71) Applicant: SHARP KABUSHIKI KAISHA, Sakai City (JP)

(72) Inventor: HIROTAKA KODAMA, Sakai City (JP)

(21) Appl. No.: 19/369,124

(22) Filed: Oct. 24, 2025

(30) Foreign Application Priority Data
Oct. 25, 2024 (JP) 2024-188063

(51) Int. Cl. H04N 1/44

(52) U.S. Cl. CPC H04N 1/4433; H04N 1/4413; H04N 1/4426; H04N 2201/0094

(57) ABSTRACT

An image forming apparatus connected to an authorization server that issues a refresh token used to issue an access token indicating permission to access a resource, the image forming apparatus includes: a volatile memory; a non-volatile storage; a communicator that receives the refresh token; and a controller, wherein the controller stores the received refresh token in the volatile memory, determines whether another refresh token used to issue the access token is stored in the non-volatile storage, does not store the received refresh token in the non-volatile storage when the other refresh token is stored in the non-volatile storage, and stores the received refresh token in the non-volatile storage when the other refresh token is not stored in the non-volatile storage.

### CROSS-REFERENCE TO RELATED APPLICATION

The present application claims priority from Japanese Application JP2024-188063, the content to which is hereby incorporated by reference into this application.

### BACKGROUND OF THE INVENTION

### 1. Field of the Invention

The present disclosure relates to an image forming apparatus and a system.

### 2. Description of the Related Art

In recent years, OAuth using a token has been used to authorize an access to a resource without sharing a password.

In a solid-state drive including DRAM logical flash and a flash memory, there has been known a technique in which a system bus performs reading and writing to the DRAM logical flash rather than the flash memory.

### SUMMARY OF THE INVENTION

In a system using OAuth, a client accesses a resource server having a resource by using a token issued by an authorization server. When the client stores, each time, the token issued by the authorization server into a storage, it is necessary to access the storage every time the token is stored or read. For example, when the client periodically polls the resource server by using the token, the access to the storage occurs frequently, which may affect the lifespan of the storage.

An aspect of the present disclosure has an object to provide an image forming apparatus and the like that reduce the number of accesses to a non-volatile storage.

An image forming apparatus according to an aspect of the present disclosure is an image forming apparatus connected to an authorization server that issues a refresh token used to issue an access token indicating permission to access a resource, and includes a volatile memory, a non-volatile storage, a communicator that receives the refresh token, and a controller, wherein the controller stores the received refresh token in the volatile memory, determines whether another refresh token used to issue the access token is stored in the non-volatile storage, does not store the received refresh token in the non-volatile storage when the other refresh token is stored in the non-volatile storage, and stores the received refresh token in the non-volatile storage when the other refresh token is not stored in the non-volatile storage.

A system according to an aspect of the present disclosure includes an image forming apparatus and an authorization server that issues a refresh token used to issue an access token indicating permission to access a resource connected to the image forming apparatus. The image forming apparatus is an image forming apparatus connected to the authorization server that issues a refresh token used to issue an access token indicating permission to access a resource, and includes a volatile memory, a non-volatile storage, a communicator that receives the refresh token, and a controller, wherein the controller stores the received refresh token in the volatile memory, determines whether another refresh token used to issue the access token is stored in the non-volatile storage, does not store the received refresh token in the non-volatile storage when the other refresh token is stored in the non-volatile storage, and stores the received refresh token in the non-volatile storage when the other refresh token is not stored in the non-volatile storage.

According to an image forming apparatus according to an aspect of the present disclosure, the number of accesses to a non-volatile storage can be reduced.

### BRIEF DESCRIPTION OF THE DRAWINGS

FIG. 1 is a configuration diagram of a system according to an embodiment.

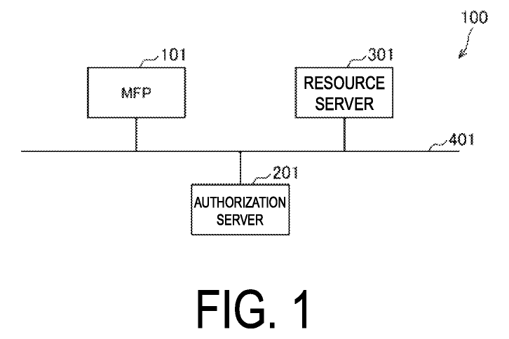

FIG. 2 is a functional block diagram of an MFP according to the embodiment.

FIG. 3 is a flowchart of processing for storing a refresh token according to the embodiment.

FIG. 4 is a flowchart of processing for reading a refresh token according to the embodiment.

FIG. 5 is a flowchart of processing for deleting a refresh token according to the embodiment.

FIG. 6 is a flowchart of processing for storing a refresh token according to the embodiment when power supply to a volatile memory is stopped.

### DETAILED DESCRIPTION OF THE INVENTION

An embodiment is described below with reference to the drawings. Note that, in the drawings, the same or equivalent elements are denoted by the same reference signs, and redundant descriptions are omitted.

A system 100 includes a multifunction peripheral (MFP) 101, an authorization server 201, and a resource server 301. The MFP 101, the authorization server 201, and the resource server 301 are connected via a network 401 such as a local area network (LAN), and can communicate with each other. The MFP 101 is an example of an image forming apparatus. In the system 100, OAuth is used for an access from the MFP 101 to the resource server 301.

The MFP 101 has a plurality of functions (modes) such as scanning, printing, copying, and faxing of a document. The MFP 101 receives print data such as characters and images to be printed and print setting information from a personal computer (PC) (not illustrated) or the resource server 301 that is connected via the network 401, and performs printing based on the print data. The MFP 101 accesses to a resource held by the resource server 301 by using an access token. Further, the MFP 101 requests the authorization server 201 to issue an access token by using a refresh token.

The authorization server 201 performs authentication and authorization of a user of the MFP 101, and issues an access token and a refresh token.

The resource server 301 manages and holds user resources (for example, e-mail, data, and the like), and provides services using the resources (for example, sending and receiving e-mail, storing data, and the like). For example, the MFP 101 accesses to the resource server 301 by using an access token, and acquires a desired resource from the resource server 301. The resource server 301 is, for example, an e-mail server, a file server, or the like. Note that the authorization server 201 and the resource server 301 may be the same apparatus.

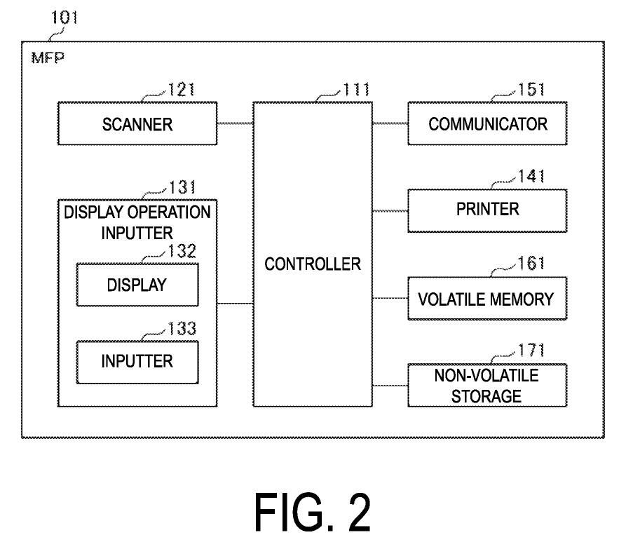

FIG. 2 is a block diagram of the MFP according to the embodiment.

The MFP 101 includes a controller 111, a scanner 121, a display operation inputter 131, a printer 141, a communicator 151, a volatile memory 161, and a non-volatile storage 171.

The controller 111 performs control of the MFP 101, such as scanning, printing, and copying. The controller 111 includes an oscillation circuit (not illustrated), a divider circuit (not illustrated), and the like, and counts the current time.

The controller 111 transmits authentication information (for example, a user ID and a password) to the authorization server 201 via the communicator 151, performs authentication and authorization between the controller 111 and the authorization server 201, and receives an authorization code from the authorization server 201 via the communicator 151. The controller 111 requests an access token and a refresh token from the authorization server 201 by using the authorization code, and receives the access token and the refresh token from the authorization server 201 via the communicator 151.

An access token is information indicating permission for a user to access a resource. An access token includes information such as an expiration period and an access right. An access token is transmitted to the resource server 301 when the MFP 101 requests a resource from the resource server 301. For example, when an access token is transmitted to the resource server 301 when user data, e-mail, or the like held by the resource server 301 is requested.

A refresh token is used to acquire an access token. A refresh token includes information such as an expiration period longer than an expiration period of an access token. For example, when an access token expires, or each time a specific command is executed, the controller 111 requests the authorization server 201 to issue an access token. Specifically, when requesting the authorization server 201 to issue an access token, the controller 111 transmits a refresh token to the authorization server 201.

The controller 111 controls storing of a refresh token in the volatile memory 161 and the non-volatile storage and deleting of a refresh token from the volatile memory 161 and the non-volatile storage. Further, the controller 111 sets the time when a refresh token is stored in the volatile memory 161 as a memory recording time, and stores the memory recording time in the volatile memory 161. The controller 111 sets the time when a refresh token is stored in the non-volatile storage as a storage recording time, and stores the storage recording time in the volatile memory 161.

The controller 111 is implemented by, for example, one or more processors such as central processing units (CPUs), or one or more logic circuits (hardware) formed in an integrated circuit (IC) chip, or the like.

The scanner 121 reads out a document placed on a document table (not illustrated) of the MFP 101 or the like, or a document transported by a document transport device (not illustrated) to generate image data of the read document.

The display operation inputter 131 displays various types of information, and receives an operation input from a user. The display operation inputter 131 is, for example, a touch panel. The display operation inputter 131 includes a display 132 and an inputter 133. The display 132 performs various types of display according to display control signals from the controller 111. The display 132 is, for example. a liquid crystal display, an organic electro-luminescence (EL) display, or the like. The inputter 133 is, for example, a position input device, and detects coordinates of a contact position with a finger, a touch pen, or the like at the inputter 133, and outputs the detected coordinates to the controller 111. Further, in the inputter 133, hardware keys such as operation buttons may be used.

The printer 141 prints characters, images, and the like on a recording medium such as paper from a feeder (not illustrated), based on print data received from the resource server 301 or print data stored in the non-volatile storage 171.

Under the control of the controller 111, the communicator 151 communicates with the authorization server 201 and the resource server 301, and performs data-conversion accompanying the communication. The communicator 151 is, for example, a wired communication interface or a wireless communication interface, and specifically, is, for example, a communication interface such as Ethernet (trade name) or Wi-Fi (trade name).

The volatile memory 161 is a volatile storage device. When power is not supplied to the volatile memory 161, the volatile memory 161 cannot hold the stored data, and the data is deleted. The volatile memory 161 stores various programs required for operating the MFP 101 and various types of data. The volatile memory 161 stores a refresh token. In addition, the volatile memory 161 stores a memory recording time at which a refresh token in stored in the volatile memory 161 and a storage recording time at which a refresh token is stored in the non-volatile storage 171. The volatile memory 161 is, for example, a random access memory (RAM) or the like.

The non-volatile storage 171 is a non-volatile storage device. The non-volatile storage 171 can hold the stored data even when power is not supplied to the non-volatile storage 171. The non-volatile storage 171 stores various programs required for operating the MFP 101 and various types of data. The non-volatile storage 171 stores an access token and a refresh token. The non-volatile storage 171 is, for example, a hard disk drive (HDD), a solid state drive (SSD), or the like.

Next, description is made on processing executed when a refresh token is received from the authorization server 201.

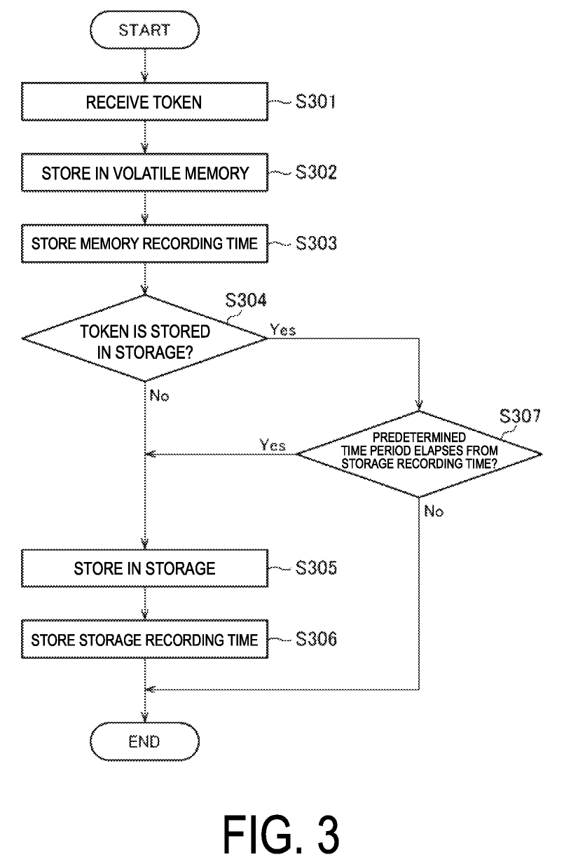

FIG. 3 is a flowchart of processing for storing a refresh token according to the embodiment.

In Step S301, the communicator 151 receives a refresh token from the authorization server 201.

In Step S302, the controller 111 stores the received refresh token in the volatile memory 161.

In Step S303, the controller 111 sets a time at which the refresh token is stored in the volatile memory 161 in Step S302 as a memory recording time, and stores the memory recording time in the volatile memory 161.

In Step S304, the controller 111 determines whether another refresh token is previously stored in the non-volatile storage 171. For example, with reference to the storage recording time stored in the volatile memory 161, the controller 111 determines whether a refresh token is previously stored in the non-volatile storage 171, based on whether a time is set as the storage recording time. When a time is set as the storage recording time, the controller 111 determines that another refresh token is previously stored in the non-volatile storage 171. When a time is not set as the storage recording time (for example, the storage recording time has a blank value), the controller 111 determines that another refresh token is not stored in the non-volatile storage 171. Whether another refresh token is stored in the non-volatile storage 171 is determined based on the storage recording time stored in the volatile memory 161. With this, the access frequency to the non-volatile storage 171 can be reduced. When it is determined that another refresh token is previously stored in the non-volatile storage 171, the control proceeds to Step S307. When it is determined that another refresh token is not previously stored in the non-volatile storage 171, the control proceeds to Step S305. Another refresh token stored in the non-volatile storage 171 and the refresh token received in Step S301 are used to issue an access token indicating permission to access a certain resource.

In Step S305, the controller 111 stores the refresh token received in Step S301 in the non-volatile storage 171. Note that, in a case in which another refresh token is previously stored, when the refresh token received in Step S301 is to be stored in the non-volatile storage 171, the controller 111 deletes the previously stored refresh token.

In Step S306, the controller 111 sets a time at which the refresh token is stored in the non-volatile storage 171 in Step S305 as a storage recording time, and stores the storage recording time in the volatile memory 161.

In Step S307, the controller 111 determines whether a predetermined time period elapsed from storage of another refresh token in the non-volatile storage 171. Specifically, for example, the controller 111 compares the storage recording time and the memory recording time with each other. When the difference between the storage recording time and the memory recording time is the predetermined time period or more, it is determined that the predetermined time period elapses from storage of another refresh token in the non-volatile storage 171. When the difference between the storage recording time and the memory recording time is less than the predetermined time period, the controller 111 determines that the predetermined time period does not elapse from storage of another refresh token in the non-volatile storage 171. Note that, when another refresh token is stored in the non-volatile storage 171, a time at which this refresh token is stored in the non-volatile storage 171 is set as the storage recording time. Further, the predetermined time period is set in advance by a user, for example.

Next, description is made on processing for reading a refresh token. For example, when an access token expires, or each time a specific command is executed, the controller 111 reads a refresh token, and requests the authorization server 201 to issue an access token by using the refresh token.

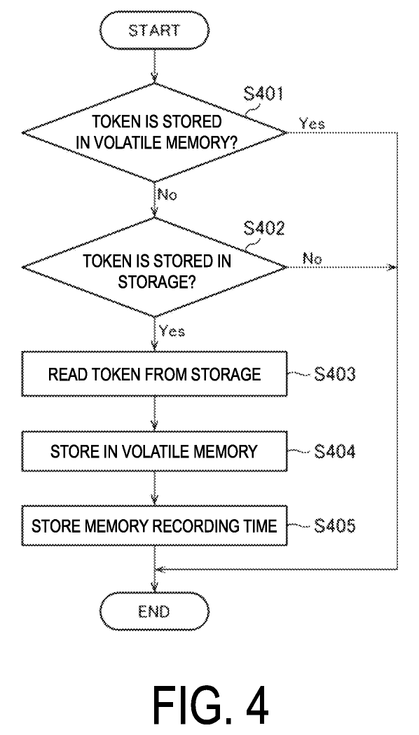

FIG. 4 is a flowchart of the processing for reading a refresh token according to the embodiment.

In Step S401, the controller 111 determines whether a refresh token is stored in the volatile memory 161. When it is determined that a refresh token is stored in the volatile memory 161, the reading processing is terminated. In other words, a refresh token is stored in the volatile memory 161, and thus the controller 111 terminates the reading processing without an access to the non-volatile storage 171, and requests reissuing of an access token or the like by using the refresh token stored in the volatile memory 161. Further, when it is determined that a refresh token is stored in the volatile memory 161, the control proceeds to Step S402.

In Step S402, the controller 111 determines whether a refresh token is stored in the non-volatile storage 171. When it is determined that a refresh token is stored in the non-volatile storage 171, the control proceeds to Step S403. When it is determined that a refresh token is not stored in the non-volatile storage 171, the reading processing is terminated.

In Step S403, the controller 111 reads the refresh token from the non-volatile storage 171.

In Step S404, the controller 111 stores the refresh token read in Step S403, in the volatile memory 161.

In Step S405, the controller 111 sets a time at which the refresh token is stored in the volatile memory 161 in Step S404 as a memory recording time, and stores the memory recording time in the volatile memory 161.

Next, description is made on processing for deleting a refresh token.

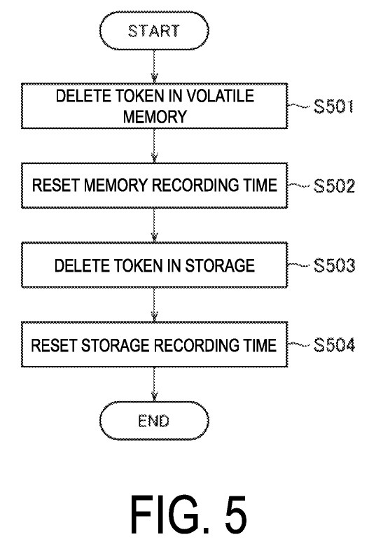

FIG. 5 is a flowchart of the processing for deleting a refresh token according to the embodiment.

In Step S501, the controller 111 deletes the refresh token stored in the volatile memory 161.

In Step S502, the controller 111 resets (initializes) the memory recording time. For example, the controller 111 sets the memory recording time to a blank value. Further, the controller 111 may delete the memory recording time from the volatile memory 161.

In Step S503, the controller 111 deletes the refresh token stored in the non-volatile storage 171.

In Step S504, the controller 111 resets (initializes) the storage recording time. For example, the controller 111 sets the storage recording time to a blank value. Further, the controller 111 may delete the storage recording time from the volatile memory 161.

Note that the controller 111 may refer to the storage recording time before Step S503. When the storage recording time is not set, which indicates that a refresh token is not stored in the non-volatile storage 171, the processing in Steps S503 and S504 may be omitted. With this, the access frequency to the non-volatile storage 171 can be reduced.

Next, description is made on processing for storing a refresh token when power supply to the volatile memory 161 is stopped, and the data stored in the volatile memory 161 is lost. The case in which power supply to the volatile memory 161 stops corresponds to transition of the MFP 101 from a power on state to a power off state, reactivation of the MFP 101, transition of the MFP 101 to a power-saving mode, or the like.

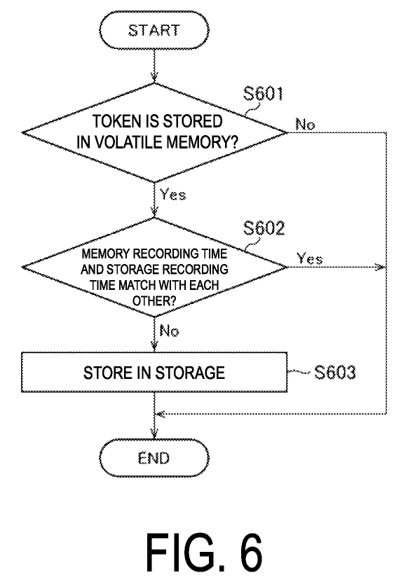

FIG. 6 is a flowchart of the processing for storing a refresh token according to the embodiment when power supply to a volatile memory is stopped.

When power supply to the volatile memory 161 is to be stopped due to transition of the MFP 101 from a power on state to a power off state, reactivation of the MFP 101, transition of the MFP 101 to a power-saving mode, or the like, the controller 111 executes the processing in FIG. 6 before power supply to the volatile memory 161 is stopped. Note that, before the processing in FIG. 6, when a refresh token is stored in the volatile memory 161, the controller 111 stores a time at which the refresh token is stored in the volatile memory 161 as a memory recording time in the volatile memory 161. When a refresh token is stored in the non-volatile storage 171, the controller 111 stores a time at which the refresh token is stored in the non-volatile storage 171 as a storage recording time in the volatile memory 161.

In Step S601, the controller 111 determines whether a refresh token is stored in the volatile memory 161. For example, with reference to the memory recording time, the controller 111 determines whether a refresh token is stored in the volatile memory 161, based on whether a time is set as the memory recording time. When a time is set as the memory recording time, the controller 111 determines that a refresh token is stored in the volatile memory 161. When a time is not set as the memory recording time (for example, the memory recording time has a blank value), the controller 111 determines that a refresh token is not stored in the volatile memory 161. When it is determined that a refresh token is stored in the volatile memory 161, the control proceeds to Step S602. When it is determined that a refresh token is not stored in the volatile memory 161, the processing is terminated without an access to the non-volatile storage 171.

In Step S602, the controller 111 determines whether the memory recording time and the storage recording time match with each other. When it is determined that the memory recording time and the storage recording time match with each other, the processing is terminated without an access to the non-volatile storage 171. When it is determined that the memory recording time and the storage recording time do not match with each other, the control proceeds to Step S603.

In Step S603, the controller 111 stores the refresh token stored in the volatile memory 161 in the non-volatile storage 171.

According to the image forming apparatus according to the embodiment, when the predetermined time period does not elapse from storage of a refresh token in the non-volatile storage, a refresh token that is newly received is not stored in the non-volatile storage. With this, the number of accesses to the non-volatile storage can be reduced. Further, according to the image forming apparatus according to the embodiment, when a refresh token is stored in the volatile memory, the refresh token is read from the volatile memory without an access to the non-volatile storage. With this, the number of accesses to the non-volatile storage can be reduced. In this manner, according to the image forming apparatus according to the embodiment, the number of accesses to the non-volatile storage can be reduced. With this, the lifespan of the non-volatile storage can be increased.

Further, for example, the specification of the refresh token is changed on the authorization server, and a refresh token issued before a predetermined period cannot be used in some cases. When a refresh token stored in the non-volatile storage is not updated for a long period of time, the refresh token stored in the non-volatile storage cannot be used after the specification of the refresh token is changed in some cases. According to the image forming apparatus according to the embodiment, when the predetermined time period elapses from storage of a refresh token in the non-volatile storage, a refresh token that is newly received is stored in the non-volatile storage, and the new refresh token is used. With this, it is possible to reduce the possibility that the refresh token cannot be used.

Note that the present disclosure is not limited to the embodiment described above and may be modified, and the above-described configuration can be replaced with a configuration that is substantially the same as the configuration illustrated in the embodiment described above, a configuration that achieves the same operations and effects, or a configuration that can achieve the same object.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An image forming apparatus connected to an authorization server that issues a refresh token used to issue an access token indicating permission to access a resource, the image forming apparatus comprising:
a volatile memory;
a non-volatile storage;
a communicator that receives the refresh token; and
a controller, wherein
the controller
stores the received refresh token in the volatile memory,
determines whether another refresh token used to issue the access token is stored in the non-volatile storage,
does not store the received refresh token in the non-volatile storage when the other refresh token is stored in the non-volatile storage, and
stores the received refresh token in the non-volatile storage when the other refresh token is not stored in the non-volatile storage.

2. The image forming apparatus according to claim 1, wherein
in a case in which the other refresh token is stored in the non-volatile storage, the controller
stores the received refresh token in the non-volatile storage when a first time at which the other refresh token is stored in the non-volatile storage is prior to a second time at which the received refresh token is stored in the volatile memory by a predetermined time period or more, and
does not store the received refresh token in the non-volatile storage when the first time is not prior to the second time by the predetermined time period or more.

3. The image forming apparatus according to claim 1, wherein
the controller
determines whether the received refresh token is stored in the volatile memory, and
requests the authorization server to issue the access token by using the received refresh token when it is determined that the received refresh token is stored in the volatile memory.

4. The image forming apparatus according to claim 1, wherein
in a case in which power is not supplied to the volatile memory, the controller
compares a first time at which a refresh token of the received refresh token and the other refresh token that is currently stored in the non-volatile storage is stored in the non-volatile storage with a second time at which the received refresh token is stored in the volatile memory, and
stores the received refresh token in the non-volatile storage when the first time and the second time do not match with each other.

5. A system comprising:
an image forming apparatus; and
an authorization server that issues a refresh token used to issue an access token indicating permission to access a resource connected to the image forming apparatus, wherein
the image forming apparatus includes
a volatile memory;
a non-volatile storage;
a communicator that receives the refresh token; and
a controller, and
the controller
stores the received refresh token in the volatile memory,
determines whether another refresh token used to issue the access token is stored in the non-volatile storage,
does not store the received refresh token in the non-volatile storage when the other refresh token is stored in the non-volatile storage, and
stores the received refresh token in the non-volatile storage when the other refresh token is not stored in the non-volatile storage.
